(19) United States
(12) Patent Application Publication
(10) Pub. No.: US 2007/0077422 A1
(43) Pub. Date: Apr. 5, 2007

(54) Single-coated adhesive tape

(76) Inventors: Hironobu Ishiwatari, Tokyo (JP); Koji Suzuki, Yamagata (JP)

Correspondence Address: 3M INNOVATIVE PROPERTIES COMPANY, PO BOX 33427, ST. PAUL, MN, 55133-3427, US

(21) Appl. No.: 10/579,603

(22) PCT Filed: Nov. 16, 2004
(86) PCT No.: PCT/US04/38260

§ 371 Date: May 17, 2006

(30) Foreign Application Priority Data
Nov. 19, 2003 (JP) 2003-389443

(51) Int. Cl. B32B 7/12; B32B 27/00; C09J 7/00; C09J 133/00

(52) U.S. Cl. 428/355 AC; 428/343

(57) ABSTRACT

A single-coated adhesive tape without a backing substrate is provided. The single-coated adhesive tape comprises an adhesive layer having a thickness of 30 to 1000 μm, which contains 50 to 95% by weight of a hot melt adhesive and 5 to 50% by weight of a layer having a thickness of 0.01 to 15 μm is provided on one surface of said adhesive layer.

### BACKGROUND ART

An adhesive tape is generally composed of two layers, i.e. a backing substrate and an adhesive layer provided on one surface of the backing substrate. A release layer may also be provided on the opposite side of a backing substrate from the adhesive layer. The backing substrate as a component of this tape is indispensable in order to impart ease of handling when used and to eliminate tack of the adhesive layer at the opposite side of the adherend, thus enabling it to serve as a tape.

However, backing substrates are known to have the following problems when used as a surgical tape which is applied to the human body:

(1) Because of the presence of the backing substrate, the edge portion of the tape mechanically stimulates the skin, potentially causing discomfort to the users during application of the tape, and sometimes inducing eruption of the skin. Even when using a flexible backing substrate, it is inferior in flexibility to the adhesive layer and, therefore, the discomfort cannot be completely eliminated.

(2) When rubbed with clothing during application of the tape, the edge portion of the tape may catch the clothes because of the presence of the backing substrate, and thus causing lifting at the edge portion.

(3) Because of the presence of the backing substrate, the applied tape is conspicuous.

In cases where the backing substrate is eliminated in the adhesive tape, one surface of the adhesive layer is made non-tacky. To control adhesion of the adhesive layer, a method of masking the adhesive layer by transferring non-tacky printing ink as described in Kokai (Japanese Unexamined Patent Publication) No. 2000-109763 is proposed. However, this method controls adhesion area and adhesion by partially masking a portion of the adhesive layer using non-tacky printing ink. Therefore, the method requires partial masking of the adhesive layer and does not make the entire surface of the adhesive layer non-tacky. When using the method of this invention in the production of a single-coated adhesive tape, a backing substrate is required and the backing substrate cannot be eliminated by the method of this invention.

Various adhesives have been proposed as an adhesive for medical tape as described in Kohyo (Japanese Unexamined Patent Publication) No. 2003-503540. However, a tape comprising a layer, which is formed only of the adhesive without using the backing substrate, is torn upon application because of poor tear strength. When the tape can be satisfactorily applied to the human body, the tape is easily torn by external irritant actions (for example, scratching by nails, and rubbing with clothes). Also the tape also is not easily applied upon application to the adherend because the adhesive layer has poor body.

### BRIEF DESCRIPTION OF THE DRAWINGS

FIG. 1 is a schematic cross-sectional view showing the constitution of a single-coated adhesive tape according to the present invention.

### DETAILED DESCRIPTION OF ILLUSTRATIVE EMBODIMENTS

A single-coated adhesive tape without a backing substrate and sufficient tear strength is provided.

According to the present invention, the single-coated adhesive tape comprises:

an adhesive layer having a thickness of 30 to 1000 μm, which contains 50 to 95% by weight of a hot melt adhesive and 5 to 50% by weight of a fihn-forming component, and

a non-tacky coating layer having a thickness of 0.01 to 15 μm provided on one surface of said adhesive layer, wherein

(a) a stress at 10% tension as measured at a temperature of 23° C. and a tension speed of 300 mm/min according to JIS K7115 is within a range from 0.1 to 10 N/25 mm, and

(b) a maximum stress as measured at a temperature of 23° C. and a tension speed of 300 mm/min according to JIS K7115 is within a range from 0.1 to 20 N/25 mm.

The single-coated adhesive tape of the present invention contains a hot melt adhesive and a film-forming component in a predetermined ratio in an adhesive layer having a predetermined thickness, which makes it possible to effectively retain the shape of the adhesive layer without using a backing substrate. It has been found that the single-coated adhesive tape of the present invention has excellent flexibility and body, which are particularly suited for medical use, because a stress at 10% tension is within a range from 0.1 to 10 N/25 mm and a maximum stress is within a range from 0.1 to 20 N/25 mm when tested under the conditions of a temperature of 23° C. and a tension speed of 300 mm/min according to JIS K7115. In the single-coated adhesive tape of the present invention, a comparatively thin non-tacky coating layer is provided on one surface of an adhesive layer and does not adversely affect the flexibility and body of the adhesive layer, a conventional backing substrate may. Thus, the single-coated adhesive tape of the present invention can remarkably reduce mechanical stimulation and discomfort to the human skin, elbow and knee, as the adherend upon application, and pain and damage upon removal.

The single-coated adhesive tape of the present invention preferably exhibits an elongation of 300 to 1000% when the maximum stress is applied. In this case, the single-coated adhesive tape can increase the adhesion area based on its extensibility. As a result, damage to the adherend can be effectively reduced upon removal from the adherend.

In some embodiments, the single-coated adhesive tape of the present invention provides a transparent non-tacky coating layer. In this case, the single-coated adhesive tape can be applied to the face because the tape is not conspicuous upon application.

### BEST MODE FOR CARRYING OUT THE INVENTION

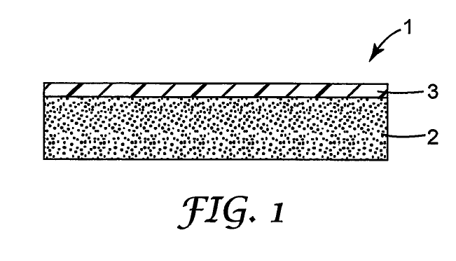

As shown in FIG. 1, a single-coated adhesive tape 1 of the present invention is composed of an adhesive layer 2, and a non-tacky coating layer 3 provided on one surface of the adhesive layer 2. The thickness of the adhesive layer 2 is from 30 to 1000 μm, preferably from 30 to 400 μm, and more preferably from 50 to 300 μm. When the thickness of the adhesive layer 2 is less than 30 μm, the tear strength of the adhesive tape decreases, resulting in poor body of the tape. On the other hand, when the thickness of the adhesive layer 2 is more than 1000 μm, the tear strength of the adhesive tape increases, however, the thickness of the tape may cause discomfort when applied to the human body. The thickness of the non-tacky coating layer 3 varies depending on the material constituting the non-tacky coating layer 3, but is preferably from 0.01 to 15 μm, more preferably from 0.01 to 10 μm, and most preferably from 0.01 to 5 μm, so as not to adversely affect the flexibility of the adhesive layer 2.

The adhesive layer 2 contains 50 to 95% by weight of a hot melt adhesive and 5 to 50% by weight of a film-forming component. When the proportion of the film-forming component is less than 5% by weight, the adhesive layer has poor tear strength and the tape may be torn by scratching by nails or rubbing against clothes. When the proportion of the film-forming component is more than 50% by weight, predetermined adhesion may not be obtained because of poor adhesion of the adhesive layer, and the flexibility of the tape deteriorates. In case of applying to the moving portions such as elbow and knee, the adhesive layer preferably contains 95 to 75% by weight of a hot melt adhesive and 5 to 25% by weight of a film-forming component. In case of applying to the non-moving portions such as head, breast and back, the adhesive layer preferably contains 75 to 50% by weight of a hot melt adhesive layer and 25 to 50% by weight of a film-forming component.

The hot melt adhesive is selected from hot melt acrylic adhesive, hot melt rubber-based adhesive, and a mixture thereof. The hot melt rubber-based adhesive is not specifically limited and may be a commonly used mixture of a synthetic rubber, such as SIS rubber and a tackifier such as rosin tackifier. Examples of the synthetic rubber include KRATON 1107 and KRATON 1112 manufactured by Kraton Polymer Co., Houston, Tex. and examples of the tackifier include FORAL85 manufactured by Hercules Inc., Wilmington Del. Examples of the other synthetic rubber include SBS, SBR, NBR, silicone rubber, acrylic rubber, butyl rubber, and ethylene-propylene rubber.

As the hot melt acrylic adhesive, for example, a copolymer of (i) at least one monoethylenically unsaturated (meth)acrylic acid ester comprising an alkyl group having at least 4 carbons on average (hereinafter referred to as a monomer A) and (ii) at least one monoethylenically unsaturated reinforcing monomer (hereinafter referred to as a monomer B) can be used.

The monomer A is a monoethylenically unsaturated (meth)acrylic acid ester (i.e. an alkyl acrylate or alkyl methacrylate) wherein the alkyl group has at least 4 carbon atoms on average. Preferably, the alkyl group of the (meth)acrylate has 4 to 14 carbon atoms. The alkyl group can optionally contain hetero atoms and can be linear or branched. When homopolymerized, these monomers yield inherently tacky polymers with glass transition temperatures which are typically less than about 10° C. Preferred such (meth)acrylate monomers have the following general formula: 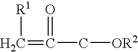
wherein R¹ is H or CH₃, the latter corresponding to where the (meth)acrylate monomer is a methacrylate monomer, R² is selected from linear or branched hydrocarbon groups and optionally including one or more hetero atoms. The number of carbon atoms in the R² group is preferably about 4 to 14, and more preferably about 4 to 8.

Examples of the monomer A include, but are not limited to, 2-methylbutyl acrylate, isooctyl acrylate, isooctyl methacrylate, lauryl acrylate, 4-methyl-2-pentyl acrylate, isoamyl acrylate, sec-butyl acrylate, n-butyl acrylate, n-hexyl acrylate, 2-ethylhexyl acrylate, 2-ethylhexyl methacrylate, n-octyl acrylate, n-octyl methacrylate, 2-methoxy-ethyl acrylate, 2-ethoxy-ethyl acrylate, n-decyl acrylate, isodecyl acrylate, isodecyl methacrylate, and isononyl acrylate. Preferred (meth)acrylates which can be used as the monomer A include isooctyl acrylate, 2-ethylhexyl acrylate, 2-methylbutyl acrylate, and n-butyl acrylate. Combinations of various monomers categorized as the monomer A can be used to make the hot melt adhesive component of the adhesive layer of the present invention.

Preferably, the hot melt acrylic adhesive of the adhesive layer of the present invention contains, based on the total weight of the hot melt acrylic adhesive, at least 85% by weight, more preferably, at least 90% by weight, and most preferably, at least 95% by weight, of the monomer A. Preferably, the hot melt acrylic adhesive of the adhesive layer of the present invention contains, based on the total weight of the hot melt acrylic adhesive, no greater than about 99% by weight, more preferably, no greater than about 98% by weight, and most preferably, no greater than about 96% by weight, of the monomer A.

The monomer B, which is a monoethylenically unsaturated reinforcing monomer, increases the glass transition temperature of the copolymer. As used herein, “reinforcing” monomers are those which increase the modulus of the adhesive, and thereby its strength. Preferably, the monomer B has a homopolymer Tg of at least about 10° C. More preferably, the monomer B is a reinforcing monoethylenically unsaturated free group-copolymerizable (meth)acrylic monomer, including acrylic acid, methacrylic acid, acrylamide, and acrylate. Examples of the monomer B include, but are not limited to, acrylamides, such as acrylamide, methacrylamide, N-methylacrylamide, N-ethylacrylamide, N-methylolacrylamide, N-hydroxyethylacrylamide, acetoneacrylamide, N,N-dimethylacrylamide, N,N-diethylacrylamide, N-ethyl-N-aminoethylacrylamide, N-ethyl-N-hydroxyethylacrylamide,N,N-dimethylolacrylamide, N,N-dihydroxyethylacrylamide, t-butylacrylamide, dimethylaminoethylacrylamide, N-octylacrylamide, and 1,1,3,3-tetramethylbutylacrylamide. Other examples of the monomer B include acrylic acid and methacrylic acid, itaconic acid, crotonic acid, maleic acid, fumaric acid, 2,2-(diethoxy)ethyl acrylate, hydroxyethyl acrylate or methacrylate, 2-hydroxypropyl acrylate or methacrylate, methylmethacrylate, isobutyl acrylate, n-butylmethacrylate, isobornyl acrylate, 2-(phenoxy)ethyl acrylate or methacrylate, biphenylyl acrylate, t-butylphenyl acrylate, cyclohexyl acrylate, dimethyladamanthyl acrylate, 2-naphthyl acrylate, phenyl acrylate, N-vinyl pyrrolidone, and N-vinyl caprolactam. Preferred reinforcing acrylic monomers which can be used as the monomer B include acrylic acid and methacrylic acid. Combinations of various reinforcing monomers categorized as a B monomer can be used to make the copolymer for the hot melt acrylic adhesive used in making the single-coated adhesive tape of the present invention.

Preferably, the hot melt acrylic adhesive of the adhesive layer of the present invention includes, based on the total weight of the hot melt acrylic adhesive, at least 1% by weight, more preferably, at least 2% by weight, and most preferably, at least 6% by weight, of the monomer B. Preferably, the hot melt acrylic adhesive of the adhesive layer of the present invention includes, based on the total weight of the hot melt acrylic adhesive, no greater than about 15% by weight, more preferably, no greater than about 10% by weight, and most preferably, no greater than about 5% by weight, of the monomer B.

The hot melt acrylic adhesive of the adhesive layer of the present invention may contain other monomers copolymerizable with the monomers A and B, such as vinyl ester and N-vinyl lactams, in addition to the monomers A and B. Examples include, but are not limited to, polystyrene macromer, poly(methylmethacrylate)macromer, poly(methoxy-ethyleneglycol)macromer, and 4-(N,N-dimethylamide)butyl acrylate; N-vinyl lactams, such as N-vinyl pyrrolidone and N-vinyl caprolactam; and N-vinylformamide. Various combinations of these monomers can be used if necessary. Preferably, an optional monomer can be included in an amount of 2% by weight to 20% by weight based on the amount of the hot melt acrylic adhesive.

In order to improve shear strength, cohesive strength, elastic modulus, initial tack and initial adhesion of the adhesive layer, the copolymer constituting the adhesive layer and the film-forming component can be crosslinked. Preferably, the crosslinker is one that is copolymerized with monomers A and B as well as other monomers. The crosslinker may produce chemical crosslinks (e.g., covalent bonds). Alternatively, it may produce physical crosslinks that result, for example, from the formation of reinforcing domains due to phase separation or acid base interaction. Suitable crosslinkers are disclosed in U.S. Pat. Nos. 4,379,201, 4,737,59, 5,506,279, and 4,554,324. Combinations of various crosslinkers can be used to make the copolymer components used in the present invention. Examples of the crosslinker include chemical crosslinker, physical crosslinker and metal crosslinker.

Examples of such chemical crosslinkers include thermal crosslinkers such as multifunctional aziridine. One example is 1,1′-(1,3-phenylenedicarbonyl)-bis-(2-methylaziridine), often referred to as “bisamide”. Such chemical crosslinkers can be added into solvent-based adhesives containing acid functionality after polymerization and activated by heat during oven drying of the coated adhesive.

Another class of chemical crosslinkers are copolymerizable monoethylenically unsaturated aromatic ketone monomer free of ortho-aromatic hydroxyl groups such as those disclosed in U.S. Pat. No. 4,737,559. Specific examples thereof include para-acryloxybenzophenone, para-acryloxyethoxybenzophenone, para-N-(methylacryloxyethyl)-carbamoylethoxybenzophenone, para-acryloxyacetophenone, ortho-acrylamideacetophenone, and acrylated anthraquinones. Other suitable crosslinkers include chemical crosslinkers which rely upon free radicals to carry out the crosslinking reaction. Reagents such as peroxides, for example, serve as a precursor of free radicals. When heated sufficiently, these precursors will generate free radicals which bring about the crosslinking reaction of the polymer chains.

Aside from thermal or photosensitive crosslinkers, crosslinking may also be achieved using radiation or high energy electromagnetic radiation, such as ultraviolet radiation, X-, γ- or e-beam radiation.

A physical crosslinker may also be used. In one embodiment, the physical crosslinker is a high Tg macromonomer such as those that include vinyl functionality and are based upon polystyrenes and polymethylmethacrylate. Such vinyl-terminated polymeric crosslinking monomers are sometimes referred to as macromolecular monomers (i.e. macromers). Such monomers are known and may be prepared by the methods disclosed in U.S. Pat. Nos. 3,786,116 and 3,842,059, as well as Y. Yamashita, Polymer Journal, 14,255-260 (1982) and K. ITO et al., Macromolecules, 13, 216-221 (1980). Typically, such monomers are prepared by anionic polymerization or free radical polymerization.

Examples of the metal crosslinker include metal-containing salts or other metal-containing compounds. Suitable metals include zinc and titanium. Examples of the metal-containing compound include zinc oxide, zinc ammonium carbonate, zinc stearate, etc.

If used, the crosslinker is used in an effective amount, by which it meant an amount that is sufficient to cause crosslinking of the adhesive to provide adequate cohesive strength to produce the desired final adhesion properties to the substrate of interest. Preferably, if used, the crosslinker is used in an amount of about 0.1 to 10 parts, based on 100 parts of the monomers.

Other additives can be included in the adhesive component and the film-forming component, or added at the time of compounding or coating of the mixture of these two components to change the properties of the adhesive. Such additives include plasticizers, tackifiers, pigments, reinforcing agents, toughening agents, fire retardants, antioxidants, and stabilizers. The additives are added in amounts sufficient to obtain the desired end-use properties. There can also be added fillers, for example, glass or polymeric bubbles or beads (which may be expanded or unexpanded), fibers, hydrophobic or hydrophilic silica, polyester, nylon, and finely ground polymeric particles such as polypropylene.

A free radical initiator is preferably added to accelerate the copolymerization of (meth)acrylate and acidic copolymers. The type of the initiator used depends on the polymerization process. Photoinitiators which are useful for polymerizing the polymerizable mixture of monomers include benzoin ethers such as benzoin methyl ether or benzoin isopropyl ether, substituted benzoin ethers such as 2-methyl-2-hydroxypropiophenone, aromatic sulfonyl chlorides such as 2-naphthalenesulfonyl chloride, and photoactive oxides such as 1-phenyl-1,1-propanedione-2-(O-ethoxycarbonyl)oxime. An example of a commercially available photoinitiator is IRGACURE 651 (2,2-dimethoxy-1,2-diphenylethan-1-one commercially available from Ciba-Geigy Corporation). Examples of suitable thermal initiator include AIBN (2,2′-azobis(isobutyronitrile)), hydroperoxides such as tert-butyl hydroperoxide, and peroxides such as benzoyl peroxide and cyclohexane peroxide. Generally, the initiator is present in an amount of about 0.005% by weight to 1% by weight based on the weight of the copolymerizable monomer.

The composition may also contain a chain transfer agent to control the molecular weight of the copolymer. Chain transfer agents are materials which regulate free radical polymerization and are generally known in the art. Suitable chain transfer agents include alcohols (e.g., methanol, ethanol and isopropanol), halogenated hydrocarbons such as carbon tetrachloride; sulfur compounds such as laurylmercaptan, butylmercaptan, ethanethiol, isooctyl thioglycolate (IOTG), 2-ethylhexyl thioglycolate, 2-ethylhexyl mercaptopropionate, 2-mercaptoimidazole, and 2-mercaptoethyl ether and mixtures thereof. The amount of the chain transfer agent which is useful depends upon the desired molecular weight and the type of the chain transfer agent. A non-alcohol chain transfer agent is typically used in amounts from about 0.001 to 10 parts by weight based on 100 parts by weight of the total monomer, preferably from 0.01 to 0.5 parts by weight, and most preferably from 0.02 to 0.20 parts by weight, and can be higher for alcohol-containing systems.

The copolymer can be polymerized by a wide variety of conventional free radical polymerization methods. Suitable methods include those described in U.S. Pat. Nos. 4,181,752, 4,833,179, 5,804,610 and 5,382,451.

For example, in a solution polymerization method, the alkyl(meth)acrylate monomer and acidic monomer, along with a suitable inert organic solvent, and a free-radical copolymerizable crosslinker, are charged into a four-neck reaction vessel equipped with a stirrer, a thermometer, a condenser, an addition funnel, and a THERMOWATCH temperature monitor. After this monomer mixture is charged into the reaction vessel, a concentrated thermal free-radical initiator solution is added to the addition funnel. The reaction vessel and addition funnel and their contents are then purged with nitrogen to create an inert atmosphere. Once purged, the solution within the vessel is heated to decompose the added thermal initiator, and the mixture is stirred during the course of the reaction. A conversion of about 98 to 99% is typically obtained in about 20 hours. If desired, the solvent can be removed to yield a hot melt coatable adhesive. If required, suitable organic solvents may be any organic liquid which is inert to the reactants and product and will not otherwise adversely affect the reaction. Such solvents include ethyl acetate, acetone, methyl ethyl ketone, and mixtures thereof. The amount of the solvent is generally about 30% by weight to 80% by weight based on the total weight of the reactants (monomer, crosslinker, initiator) and solvent.

Another polymerization method is the ultraviolet radiation (UV) initiated photopolymerization of the monomer mixture. This composition, along with suitable photoinitiator and crosslinker, is coated onto a flexible carrier web and polymerized in an inert, i.e. oxygen-free, atmosphere, such as a nitrogen atmosphere, for example. A sufficiently inert atmosphere can be achieved by covering a layer of the photoactive coating with a plastic film which is substantially transparent to ultraviolet radiation, and irradiating through the film in air using fluorescent-type ultraviolet lamps that generally give a total radiation dose of about 500 milliJoules/cm².

Solventless polymerization methods, such as the continuous free radical polymerization in an extruder described in U.S. Pat. Nos. 4,619,979 and 4,843,134; the essentially adibatic polymerization methods using a batch reactor described in U.S. Pat. No. 5,637,646; and the methods described for polymerizing packaged pre-adhesive compositions described in U.S. Pat. No. 5,804,610 may also be utilized to prepare the polymers.

The film-forming component is preferably composed of a thermoplastic resin which is solid at normal temperature and does not exhibit tackness, and more preferably a thermoplastic resin having a softening point within a range from 25 to 300° C. Specifically, the thermoplastic resin is selected from the group consisting of polyvinyl, polyester polyurethane, cellulose resin, polyamide, and acetal resin. Examples of the polyvinyl include polyolefin and acrylic resin; examples of the polyolefin include polyethylene (low-density polyethylene, high-density polyethylene, linear low-density polyethylene), polypropylene, polystyrene, polyvinyl alcohol, polyvinyl acetate, and ethylene-vinyl acetate copolymer; and examples of the acrylic resin include acrylonitrile-butadiene-styrene resin, acrylonitrile-styrene resin, methyl polymethacrylate. Examples of polyester include polyethylene terephthalate, and polycarbonate. Examples of cellulose resin include cellulose acetate. Preferably, the film-forming component is uniformly dispersed in the hot melt adhesive component.

The non-tacky coating layer to be provided on one surface of the adhesive layer is obtained by eliminating tackness on one surface of the adhesive layer without eliminating flexibility of the adhesive layer. The thickness of the non-tacky coating layer is from 0.01 to 15 μm, preferably from 0.01 to 10 μm, and more preferably from 0.01 to 5 μm. When the thickness is more than 15 μm, the flexibility of the single-coated adhesive tape is adversely affected. On the other hand, when the thickness is less than 0.01 μm, the tackness of one surface of the adhesive layer cannot be eliminated and a single-coated adhesive tape cannot be obtained. The non-tacky coating layer is composed of commonly used releasing agents, for example, acrylic releasant, silicone releasant, polyurethane releasant (e.g., TPR6501 manufactured by GE-Toshiba Silicone Co., Ltd.); and non-tacky powders, for example, organic powders (e.g., starch, wheat flour or dogtooth violet starch), inorganic powders, metal powders, and pigments (e.g., titanium oxide, carbon).

The single-coated adhesive tape of the present invention can be produced by the following steps of:

(1) uniformly kneading the hot melt adhesive and the film-forming component while heating to prepare an adhesive mixture;

(2) coating the resulting adhesive mixture onto a lubricating surface of a release paper in a predetermined thickness while maintaining at a predetermined temperature to form an adhesive layer;

(3) thinly coating the releasing agent onto a lubricating surface of another release paper in a predetermined thickness to form a non-tacky coating layer; and

(4) contacting the non-tacky coating layer closely with the adhesive layer, thereby to transfer to the adhesive layer.

The single-coated adhesive tape of the present invention can also be produced by the following steps of:

(1) uniformly kneading the hot melt adhesive and the film-forming component while heating to prepare an adhesive mixture;

(2) thinly coating the releasing agent onto a lubricating surface of a release paper in a predetermined thickness to form a non-tacky coating layer; and

(3) coating the adhesive mixture onto the non-tacky coating layer in a predetermined thickness while maintaining at a predetermined temperature to form an adhesive layer;

The single-coated adhesive tape of the present invention can also be produced by the following steps of:

(1) uniformly kneading the hot melt adhesive and the film-forming component while heating to prepare an adhesive mixture;

(2) coating the resulting adhesive mixture onto a lubricating surface of a release paper in a predetermined thickness while maintaining at a predetermined temperature to form an adhesive layer; and

(3) thinly coating non-tacky fine powders onto the adhesive layer using an electrostatic coater to form a non-tacky coating layer.

The single-coated adhesive tape of the present invention exhibits a stress within a range from 0.1 to 10 N/25 mm at 10% tension. Furthermore, the single-coated adhesive tape of the present invention exhibits a maximum stress within a range from 0.1 to 20 N/25 mm, preferably from 0.1 to 15 N/25 mm, and more preferably from 0.1 to 10 N/25 mm. As a result, the single-coated adhesive tape of the present invention exhibits satisfactory flexibility and body.

Also the single-coated adhesive tape of the present invention preferably exhibits an elongation at maximum stress within a range from 30 to 1000%, more preferably from 50 to 1000%, and most preferably from 100 to 1000%. Since the single-coated adhesive tape exhibits such elongation, it becomes possible to release stretch the tape upon removal and pain upon removal can be reduced when the single-coated adhesive tape of the present invention is applied to the human body.

The stress at 10% tension means a stress achieved when a specimen is stretched by 10% under the conditions of a temperature of 23° C. and a tension speed of 300 mm/min according to JIS K7115 using a tensile testing machine. The maximum stress means a maximum stress achieved when a specimen is stretched under the conditions of a temperature of 23° C. and a tension speed of 300 mm/min according to JIS K7115 using a tensile testing machine (specimen width: 25 mm, chuck distance: 50 mm). The elongation means an elongation at maximum stress achieved when a specimen is stretched by 10% under the conditions of a temperature of 23° C. and a tension speed of 300 mm/min according to JIS K7115 using a tensile testing machine (specimen width: 25 mm, chuck distance: 50 mm).

### EXAMPLES

### Example 1

In a 2 liter flask, 750 g of deionized water was charged and then 1.5 g of ZnO and 0.75 g of a hydrophilic silica were added. The flask was purged with nitrogen and then heated to 55° C. until ZnO and silica are dispersed. Separately, 2.5 g of VAZO™ 64 (initiator manufactured by E.I. Dupont) and 0.5 g of isoocty thioglycolate were added to a mixture of 480 g of isooctyl acrylate, 20 g of methyl methacrylate and 1 g of acryloxybenzophenone while stirring. The solution containing an initiator and a chain extender thus obtained was added to the above aqueous solution while stirring vigorously (700 rpm) to obtain a suspension. The reaction was continued for at least 6 hours while purging with nitrogen and the reaction temperature was controlled to 70° C. or lower during the reaction. Beads thus formed were collected by filtration and then washed with deionized water. These beads were dried to obtain an acrylic adhesive as a hot melt adhesive.

The resulting hot melt adhesive and a low-density polyethylene (manufactured by Nippon Polyolefin Co., Ltd. under the trade name of J-REX LD) were uniformly kneaded at 165° C. in a weight ratio of 90:10 using a twin-screw extruder to obtain an adhesive mixture. The mixture was coated onto a lubricating surface of a release paper (manufactured by Kaito Chemical Co., Ltd. under the trade name of SLK-50W) at 140° C. in a thickness of 50 μm and then irradiated with ultraviolet radiation to form an adhesive layer.

A silicone releasant (manufactured by GE-Toshiba Silicone Co., Ltd. under the trade name of TPR6501) was coated onto the entire lubricating surface of another release paper (manufactured by Kaito Chemical Co., Ltd. under the trade name of SLK-50W) in a thickness of 3 μm and then the silicone releasant was dried in an oven at 70° C. to form a non-tacky coating layer. The non-tacky coating layer was transferred by closely contacting with the adhesive layer to obtain a single-coated adhesive tape of the present invention.

### Example 2

In the same manner as in Example 1, except that the weight ratio of the hot melt adhesive to the low-density polyethylene was adjusted to 82.5:17.5 and the thickness of the adhesive layer was adjusted to 100 μm, a single-coated adhesive tape was obtained.

### Example 3

In the same manner as in Example 1, except that the weight ratio of the hot melt adhesive to the low-density polyethylene was adjusted to 75:25 and the thickness of the adhesive layer was adjusted to 100 μm, a single-coated adhesive tape was obtained.

### Example 4

In the same manner as in Example 1, except that the weight ratio of the hot melt adhesive to the low-density polyethylene was adjusted to 70:30 and the thickness of the adhesive layer was adjusted to 100 μm, a single-coated adhesive tape was obtained.

### Example 5

In the same manner as in Example 1, except that the weight ratio of the hot melt adhesive to the low-density polyethylene was adjusted to 75:25 and the thickness of the adhesive layer was adjusted to 175 μm, a single-coated adhesive tape was obtained.

### Example 6

In the same manner as in Example 1, except that the weight ratio of the hot melt adhesive to the low-density polyethylene was adjusted to 82.5:17.5 and the thickness of the adhesive layer was adjusted to 175 μm, a single-coated adhesive tape was obtained.

### Example 7

In the same manner as in Example 1, except that the weight ratio of the hot melt adhesive to the low-density polyethylene was adjusted to 82.5:17.5 and the thickness of the adhesive layer was adjusted to 250 μm, a single-coated adhesive tape was obtained.

### Example 8

In the same manner as in Example 1, except that the weight ratio of the hot melt adhesive to the low-density polyethylene was adjusted to 82.5:17.5 and the thickness of the adhesive layer was adjusted to 320 μm, a single-coated adhesive tape was obtained.

### Example 9

In the same manner as in Example 1, except that the weight ratio of the hot melt adhesive to the low-density polyethylene was adjusted to 70:30 and the thickness of the adhesive layer was adjusted to 100 μm and, furthermore, printing ink (manufactured by Dainichiseika Color & Chemicals Mfg. Co., Ltd. under the trade name of NT-HR Color) was used in place of the silicone releasant, a single-coated adhesive tape was obtained.

### Example 10

In the same manner as in Example 1, except that the weight ratio of the hot melt adhesive to the low-density polyethylene was adjusted to 70:30 and the thickness of the adhesive layer was adjusted to 100 μm and, furthermore, wheat flour was used in place of the silicone releasant, a single-coated adhesive tape was obtained.

### Example 11

In the same manner as in Example 1, except that a low-density linear polyethylene (manufactured by Nippon Polyolefin Co., Ltd. under the trade name of J-REX LL) was used in place of the low-density polyethylene and the weight ratio of the hot melt adhesive to the low-density linear polyethylene was adjusted to 82.5:17.5, a single-coated adhesive tape was obtained.

### Example 12

In the same manner as in Example 1, except that an ethylene-vinyl acetate copolymer (manufactured by Nippon Polyolefin Co., Ltd. under the trade name of J-REX EVA) was used in place of the low-density polyethylene and the weight ratio of the hot melt adhesive to the low-density linear polyethylene was adjusted to 85:15, a single-coated adhesive tape was obtained.

### Example 13

In the same manner as in Example 1, except that a mixture of the acrylic adhesive described in Example 1 and an ethyl acrylate/acrylic acid (92/8) copolymer (weight ratio: 68/12) was used as the hot melt adhesive and the weight ratio of the mixture to the low-density linear polyethylene was adjusted to 70:30, a single-coated adhesive tape was obtained.

### Example 14

In the same manner as in Example 1, except that a mixture (weight ratio: 70/15) of the acrylic adhesive described in Example 1 and a rubber (SIS rubber manufactured by Kraton Polymer Co. under the trade name of KRATON-1112) was used as the hot melt adhesive and the weight ratio of the mixture to the low-density linear polyethylene was adjusted to 85:15, a single-coated adhesive tape was obtained.

### Example 15

In the same manner as in Example 1, except that a mixture (weight ratio: 45/45) a rubber (SIS rubber manufactured by Kraton Polymer Co. under the trade name of KRATON-1112) and a rosin tackfier (manufactured by Hercules Inc., Wilmington Del. under the trade name of FORAL 85) was used as the hot melt adhesive and the weight ratio of the mixture to the low-density linear polyethylene was adjusted to 90:10, a single-coated adhesive tape was obtained.

### Comparative Example 1

The hot melt adhesive produced in Example 1 and a low-density polyethylene (manufactured by Nippon Polyolefin Co., Ltd. under the trade name of J-REX LD) were uniformly kneaded at 165° C. in a weight ratio of 82.5:17.5 using a twin-screw extruder to obtain an adhesive mixture. The mixture was coated onto a rayon nonwoven fabric having a basis weight of 50 g/m² at 140° C in a thickness of 50 μm and then irradiated with ultraviolet radiation (line speed: 30 m/min, UV intensity: 25 mJ) to obtain a conventional single-coated adhesive tape comprising a backing substrate.

### Comparative Example 2

In the same manner as in Example 1, except that the film-forming component was not added, a single-coated adhesive tape was obtained. The hot melt adhesive produced in Example 1 was uniformly kneaded at 165° C. using a twin-screw extruder to obtain an adhesive mixture. The mixture was coated onto a lubricating surface of a release paper (manufactured by Kaito Chemical Co., Ltd. under the trade name of SLK-50W) at 140° C. in a thickness of 150 μm and then irradiated with ultraviolet radiation to form an adhesive layer. A silicone releasant (manufactured by GE-Toshiba Silicone Co., Ltd. under the trade name of TPR6501) was coated onto the entire lubricating surface of another release paper (manufactured by Kaito Chemical Co., Ltd. under the trade name of SLK-50W) in a thickness of 3 μm and then the silicone releasant was dried in an oven at 70° C. to form a non-tacky coating layer. The non-tacky coating layer was transferred by closely contacting with the adhesive layer to obtain a single-coated adhesive tape.

### Comparative Example 3

In the same manner as in Comparative Example 2, except that the thickness of the adhesive layer was adjusted to 300 μm, an adhesive tape was obtained.

### Comparative Example 4

A commercially available surgical tape (manufactured by NICHIBAN CO., LTD. under the trade name of SKINERGATE) was used.

### Comparative Example 5

In the same manner as in Example 2, except that the thickness of the adhesive layer was adjusted to 1050 μm, a single-coated adhesive tape was obtained.

### Comparative Example 6

In the same manner as in Example 2, except that the thickness of the adhesive layer was adjusted to 20 μm, a single-coated adhesive tape was obtained.

### Comparative Example 7

In the same manner as in Example 2, except that the ratio of the hot melt adhesive to the film-forming component was adjusted to 40:60, a single-coated adhesive tape was obtained.

The single-coated adhesive tapes produced described above were evaluated by the following procedures.

Stress at 10% Tension

The stress was measured by stretching a specimen by 10% under the conditions of a temperature of 23° C. and a tension speed of 300 mm/min according to JIS K7115 using a tensile testing machine (specimen width: 25 mm, chuck distance: 50 mm).

Maximum Stress and Elongation at Maximum Stress

The maximum stress and elongation were measured by stretching a specimen under the conditions of a temperature of 23° C. and a tension speed of 300 mm/min according to JIS K7115 using a tensile testing machine (specimen width: 25 mm, chuck distance: 50 mm).

Pain Upon Removal

Tapes, each measuring 25 mm×50 mm, were applied to the arm of each of eight healthy subjects and the subjects were asked about the perception of pain upon removal after 24 hours. The evaluation was conducted according to the following criteria.

A: no pain

B: no pain, tickle

C: slight pain

D:pain

Discomfort During Application

Tapes, each measuring 25 mm×50 mm, were applied to the arm of each of eight healthy subjects and the subjects were asked about discomfort during application. The evaluation was conducted according to the following criteria.

A: no discomfort that enables elimination of the perception upon application

B: sometimes feel some discomfort

C: sometimes feel severe discomfort

D: always feel severe discomfort

Retention of Texture of Skin

Tapes, each measuring 25 mm×50 mm, were applied to the arm of each of eight healthy subjects and were removed after 24 hours. Then, texture of the skin was observed by Prescope™ and retention of texture of the skin was visually evaluated according to the following criteria.

A: good retention of skin

B: retention of skin

C: no retention of skin

D: denudation occurred

Lifting

Tapes, each measuring 25 mm×50 mm, were applied to the arm of each of eight healthy subjects and were removed after 24 hours. Then, it was evaluated according to the following criteria whether or not lifting of the tape occurs.

A: no lifting

B: lifting occurred at the edge portion of the tape

D: lifting also occurred at the center portion of the tape

Wear Resistance During Application

Tapes, each measuring 25 mm×50 mm, were applied to the arm of each of eight healthy subjects and were removed after 24 hours. Then, it was evaluated according to the following criteria whether or not the tape is torn.

A: tape was not torn

D: tape was torn

Ease of Application

Tapes, each measuring 25 mm×50 mm, were applied to the arm of each of eight healthy subjects and the subjects were asked about ease of application. The evaluation was conducted according to the following criteria.

A: good ease of application (applied without causing any problem)

B: no problem

C: applied with some difficulty

D: applied with difficulty because of no body

Ease of Removal

Tapes, each measuring 25 mm×50 mm, were applied to the arm of each of eight healthy subjects and the subjects were asked about ease of removal after 24 hours. The evaluation was conducted according to the following criteria.

A: good ease of removal (edge portion was found with ease and tape was not torn during application)

B: edge portion was found with difficulty, good ease of removal (tape was not torn during application)

C: tape was tom upon removal because of poor strength and was removed with slight difficulty

D: tape was tom upon removal because of poor strength and was removed with difficulty

The above results are summarized in Table 1 and Table 2 below.

TABLE 1

| | Example No. | | | | | | | |
|---|---|---|---|---|---|---|---|---|
| | 1 | 2 | 3 | 4 | 5 | 6 | 7 | 8 |
| Stress at 10% tension | 0.28 | 2.4 | 3.8 | 4.0 | 4.9 | 3.5 | 3.9 | 3.8 |
| (N/25 mm) | | | | | | | | |
| Elongation at maximum stress | 220 | 220 | 200 | 100 | 250 | 270 | 210 | 170 |
| (%) | | | | | | | | |
| Maximum stress (N/25 mm) | 4.0 | 5.2 | 6.9 | 8.0 | 8.0 | 5.8 | 5.8 | 5.5 |
| Pain upon removal | A | A | A | A | A | A | A | A |
| Discomfort during application | A | A | A | A | A | A | B | B |
| Texture of skin | B | A | A | A | A | A | A | A |
| Lifting | A | A | A | A | A | A | A | A |
| Water resistance | A | A | A | A | A | A | A | A |
| Wear resistance | B | A | A | A | A | A | A | A |
| Ease of application | C | A | A | A | A | A | A | A |
| Ease of removal | B | A | A | A | A | A | A | A |

| | 9 | 10 | 11 | 12 | 13 | 14 | 15 |
|---|---|---|---|---|---|---|---|
| Stress at 10% tension | 4.0 | 4.0 | 2.7 | 0.40 | 0.50 | 0.40 | 0.64 |
| (N/25 mm) | | | | | | | |
| Elongation at maximum stress | 100 | 100 | 300 | 200 | 220 | 180 | 300 |
| (%) | | | | | | | |
| Maximum stress (N/25 mm) | 8.0 | 8.0 | 5.0 | 4.0 | 4.1 | 1.8 | 5.0 |
| Pain upon removal | A | A | A | A | A | A | A |
| Discomfort during application | A | A | A | A | A | A | A |
| Texture of skin | A | A | A | A | A | A | A |
| Lifting | A | A | A | A | A | A | A |
| Water resistance | A | A | A | A | A | A | A |
| Wear resistance | A | A | A | A | A | A | A |
| Ease of application | A | A | A | A | A | A | A |
| Ease of removal | A | A | A | A | A | A | A |

TABLE 2

| | Comparative Example No. | | | | | | |
|---|---|---|---|---|---|---|---|
| | 1 | 2 | 3 | 4 | 5 | 6 | 7 |
| Stress at 10% tension (N/25 mm) | 26.6 | 0.12 | 0.26 | 7.00 | — | 0.05 | — |
| Elongation at maximum stress (%) | 15 | 330 | 332 | 35 | — | 200 | — |
| Maximum stress (N/25 mm) | 40.1 | 1.50 | 2.0 | 12 | — | 0.1 | — |
| Pain upon removal | C | C | C | C | — | B | — |
| Discomfort during application | D | A | A | D | — | A | — |
| Texture of skin | C | B | B | B | — | A | — |
| Lifting | B | A | A | D | — | A | — |
| Water resistance | D | A | A | D | — | B | — |
| Wear resistance | A | D | D | A | — | C | — |
| Ease of application | A | D | D | A | — | D | — |
| Ease of removal | A | D | D | A | — | D | — |

Comparative Example 5: too thick to coat
Comparative Example 7: impossible to knead

Oil (Sebum) Adsorptivity

This evaluation was conducted to confirm whether or not the adhesive in the present invention can retain adhesion to the portion with a large amount of oil (sebum). The hot melt adhesive and the film-forming component produced in Example 1 were kneaded in each ratio shown Table 3 to obtain adhesive mixtures. Each of the adhesive mixture was coated onto a rayon nonwoven fabric (manufactured by 3M Company under the trade name of MICROPORE Rayon Nonwoven Fabric) in a thickness of 50 μm at 140° C. and then irradiated with ultraviolet radiation to obtain single-coated adhesive tapes comprising a backing substrate.

TABLE 3

| | Sample 1 | Sample 2 | Sample 3 | Sample 4 |
|---|---|---|---|---|
| Hot melt adhesive | 90% | 80% | 70% | 100% |
| Film-forming component | 10% | 20% | 30% | 0% |

Each of the resulting single-coated adhesive tapes (25 mm×75 mm) was coated onto two kinds of SUS plates, a SUS plate (A) and a SUS plate (B) coated thinly with oil (manufactured by Shell Chemical Co. under the trade name of Shellflex 371JY), press-contacted by moving a 2 kg roller back and forth at a speed of 300 mm/min, and then removed under the conditions of a peel angle of 180° and a speed of 300 mm/min. The stress required to remove the tape was measured. The results are shown in Table 4 below.

TABLE 4

| | Sample 1 | Sample 2 | Sample 3 | Sample 4 |
|---|---|---|---|---|
| 180° peel strength upon | 7.4 | 9.3 | 8.8 | 7.1 |
| removal from SUS (A) | | | | |
| (N/25 mm) | | | | |
| 180° peel strength upon | 9.0 | 11.9 | 15.4 | 6.2 |
| removal from SUS (B) | | | | |
| (N/25 mm) | | | | |

As described above, it has been found that the adhesive, which is obtained by adding polyethylene as the film-forming component to the hot melt resin as the acrylic adhesive, can more strongly adhere to the adherend coated with oil. It is deemed that the adhesive obtained by adding polyethylene to the acrylic adhesive is scarcely affected by sebum when applied to the human body and also sufficiently functions even when applied to the portion with a large amount of sebum.

As described above, the present invention provides a single-coated adhesive tape which does not require a substrate which serves as a backing. The single-coated adhesive tape of the present invention can retain the shape by its adhesive layer without using the backing substrate and exhibits excellent flexibility and body, and can also reduce mechanical stimulation, pain, damage and discomfort to the human skin as the adherend, and can reduce damage to the adherend upon removal from the adherend.

### INDUSTRIAL APPLICABILITY

The single-coated adhesive tape of the present invention is suited for fixation to the human body, particularly human body of users with sensitive or weak skin because it causes less discomfort to users during application and exhibits low adhesion and less stimulation upon removal. Also the single-coated adhesive tape is suited for use as magnetic health appliances and skin protectors (for prevention of shoe soreness) because it causes less discomfort and is scarcely removed and also has excellent water resistance. Furthermore, the single-coated adhesive tape is suited for application to the portion of the body capable of largely expanding and contracting portion such as joint because of its excellent extensibility. Furthermore, the single-coated adhesive tape is suited for application to the conspicuous portion such as face because it is thin and transparent and is not conspicuous.

1. A single-coated adhesive tape comprising:
an adhesive layer having a thickness of 30 to 1000 μm, which contains 50 to 95% by weight of a hot melt adhesive and 5 to 50% by weight of a film-forming component, and
a non-tacky coating layer having a thickness of 0.01 to 15 μm provided on one surface of said adhesive layer, wherein
(a) a stress at 10% tension as measured at a temperature of 23° C. and a tension speed of 300 mm/min according to JIS K7115 is within a range from 0.1 to 10 N/25 mm, and
(b) a maximum stress as measured at a temperature of 23° C. and a tension speed of 300 mm/min according to JIS K7115 is within a range from 0.1 to 20 N/25 mm.

2. The single-coated adhesive tape according to claim 1, which exhibits an elongation of 30 to 1000% when said maximum stress is applied by testing at a temperature of 23° C. and a tension speed of 300 mm/min according to JIS K7115.

3. The single-coated adhesive tape according to claim 2, wherein said hot melt adhesive comprises a polymer of:
(i) at least one monoethylenically unsaturated (meth)acrylic acid ester comprising an alkyl group having at least 4 carbons on average, and
(ii) at least one monoethylenically unsaturated reinforcing monomer.

4. The single-coated adhesive tape according to claim 1, wherein said hot melt adhesive contains an rubber-based adhesive.

5. The single-coated adhesive tape according to claim 1, wherein said film-forming component is composed of a thermoplastic resin having a softening point within a range from 25 to 300° C.

6. The single-coated adhesive tape according to claim 5, wherein said thermoplastic resin is selected from the group consisting of polyvinyl, polyester, polyurethane, cellulose resin, polyamide and acetal resin.

7. The single-coated adhesive tape according to claim 1, wherein said non-tacky coating layer is transparent.
